(19) United States
(12) Patent Application Publication
(10) Pub. No.: US 2009/0267423 A1
(43) Pub. Date: Oct. 29, 2009

(54) ELECTROMAGNETIC EXCITER

(76) Inventors: Hiroo KAJIWARA, Yamanashi-ken (JP); Naoki Miura, Yamanashi-ken (JP)

Correspondence Address: WENDEROTH, LIND & PONACK, L.L.P., 1030 15th Street, N.W.,, Suite 400 East, Washington, DC, 20005-1503, US

(21) Appl. No.: 12/427,446

(22) Filed: Apr. 21, 2009

(30) Foreign Application Priority Data
Apr. 23, 2008 (JP) 2008-112026
May 22, 2008 (JP) 2008-134658
Jul. 9, 2008 (JP) 2008-178633
Oct. 30, 2008 (JP) 2008-280390
Nov. 12, 2008 (JP) 2008-290299
Jan. 9, 2009 (JP) 2009-003850

(51) Int. Cl. H02K 33/00

(52) U.S. Cl. 310/36; 310/38

(57) ABSTRACT

An electromagnetic exciter that enables thickness reduction has a casing, a stator having an electromagnet and fixed in the casing, an oscillator having a permanent magnet, and an elastic support member that positions the oscillator in horizontally-opposed relation to the stator at a distance between them and that supports the oscillator oscillatably in a direction parallel to the stator. The elastic support member has a fixed portion fixed to the casing and a pair of arms extending from the fixed portion toward the stator along side surfaces of the oscillator to support the oscillator oscillatably. The oscillator is oscillated by an alternating magnetic field generated by application of an alternating voltage to the electromagnet of the stator.

This application claims priority under 35 U.S.C. §119 to Japanese Patent application No. JP2008-112026 filed on Apr. 23, 2008, Japanese Patent application No. JP2008-134658 filed on May 22, 2008, Japanese Patent application No. JP2008-178633 filed on Jul. 9, 2008, Japanese Patent application No. JP2008-280390 filed on Oct. 30, 2008, Japanese Patent application No. JP2008-290299 filed on Nov. 12, 2008, and Japanese Patent application No. JP2009-003850 filed on Jan. 9, 2009, the entire contents of which are hereby incorporated by reference.

### TECHNICAL FIELD

The present invention relates to an electromagnetic exciter that can be incorporated in thin mobile devices such as mobile phones.

### RELATED ART

Conventionally, thin mobile devices such as mobile phones generate ringtones to indicate an incoming call or a schedule and additionally have a vibration-generating device to inform the user of an incoming call or the like by vibration in trains or at meetings where noises should not be made.

Conventional vibration-generating devices have an eccentric rotary weight attached to a rotating shaft of a motor to generate vibration by rotating the rotary weight with the motor to inform the user of an incoming call. A vibration-generating device with such a structure, however, has a circular cylindrical configuration as a whole due to the cylindrical motor configuration and the rotary weight configurations and is therefore unsuitable for thickness reduction. Further, because the eccentric weight is rotated to generate vibration, the rotating shaft is subjected to an excessive stress, which gives rise to problems in terms of durability and reliability.

There have been proposed transverse vibration-type electromagnetic exciters that can achieve thickness reduction as compared to the above-described cylindrical vibration-generating device (for example, see Japanese Patent Application Publication Nos. 2001-179178 and 2002-143770). A transverse vibration-type electromagnetic exciter has an electromagnet block fixed to a terminal-equipped base and a permanent magnet block oscillatably attached to the base. The electromagnetic coil of the electromagnet block generates an alternating magnetic field in response to an alternating current applied to the coil of the electromagnet block, thus causing oscillation of the permanent magnet block to generate vibration.

The electromagnetic exciter disclosed in Japanese Patent Application Publication No. 2001-179178 has a stator having magnetic pole faces on its right and left sides, respectively, and a U-shaped oscillator having magnetic pole arms on its right and left sides, respectively. The right and left magnetic pole arms are positioned at the right and left sides, respectively, of the stator to face the right and left magnetic pole faces of the movable electromagnet. An elastic support member is secured at its one end to the oscillator and at its other end to the stator. The oscillator is vibrated transversely by applying an alternating voltage to the stator. Accordingly, this electromagnetic exciter cannot increase the amplitude of the vibration of the oscillator. In the electromagnetic exciter disclosed in Japanese Patent Application Publication No. 2002-143770, an elastic support member is secured at its one end to an oscillator and at its other end to a stator. The oscillator is disposed above the stator. Therefore, the height of the electromagnetic exciter increases, making it difficult to reduce the thickness of a mobile device into which the electromagnetic exciter is incorporated.

The present invention has been made in view of the above-described problems. Accordingly, an object of the present invention is to provide a transverse vibration-type electromagnetic exciter that enables reduction in thickness of a mobile device into which the electromagnetic exciter is incorporated.

### SUMMARY OF THE INVENTION

The present invention provides an electromagnetic exciter including a casing, a stator having an electromagnet and fixed in the casing, an oscillator having a permanent magnet, and an elastic support member that positions the oscillator in horizontally-opposed relation to the stator at a distance between each other and that supports the oscillator oscillatably in a direction parallel to the stator. The elastic support member has a fixed portion fixed to the casing and a pair of arms extending from the fixed portion toward the stator along side surfaces of the oscillator to support the oscillator oscillatably. The oscillator is oscillated by an alternating magnetic field generated by application of an alternating voltage to the electromagnet of the stator.

Specifically, at least a part of each of the arms of the elastic support member may be fixed to the associated side of the oscillator. The distal end portions of the arms may be fixed to the two sides of the oscillator, respectively.

The distal end portions of the arms of the elastic support member may be bent from both sides of the oscillator to face each other and fixed to a surface of the oscillator that faces the stator.

Deformable members may be clamped between the arms of the elastic support member and the side surfaces of the oscillator corresponding to the arms, respectively.

The pair of arms and the fixed portion of the elastic support member may be integrally formed together in a substantially U-shape.

The arms of the elastic support member, which are extending along the sides of the oscillator, are opposed each other and a distance between distal end portions of the arms is shorter than a distance between portions other than the distal end portions of the arms.

The distal ends of the pair of arms may be integrally connected together.

The permanent magnet may have been magnetized in a direction parallel to the stator and have two magnetic pole members respectively secured to the permanent magnet at opposite ends in the direction parallel to the stator.

The oscillator may further have a weight disposed between the pair of arms of the elastic support member while being disposed between the fixed portion, on the one hand, and, on the other, the permanent magnet and the two magnetic pole members. The weight may be secured to at least one of the permanent magnet and the two magnetic pole members.

The permanent magnet, the two magnetic pole members and the weight of the oscillator may be planarly disposed in the elastic support member and integrated together.

The oscillator may further have a U-shaped magnetic pole member having a pair of magnetic pole portions and a connecting portion that connects together the magnetic pole portions, the magnetic pole portions extending toward the stator at a distance between them in a direction parallel to the stator. The permanent magnet may be disposed within the magnetic pole member.

The oscillator may further have a weight disposed between the pair of arms of the elastic support member and secured to the magnetic pole member.

The distal end portions of the arms of the elastic support member may be secured to the two magnetic pole members, respectively.

The electromagnetic exciter may further include a substrate to which the stator and the oscillator are mounted. The casing may be disposed on the substrate, and the elastic support member may support the oscillator oscillatably in a direction parallel to the substrate.

The fixed portion of the elastic support member may be fixed to a side wall of the casing.

The fixed portion of the pair of integrally connected arms of the elastic support member may be fixed to the casing.

The permanent magnet of the oscillator may be secured to a part of the magnetic pole member.

The permanent magnet of the oscillator may be spaced from the pair of magnetic pole portions of the magnetic pole member and secured to the connecting portion of the magnetic pole member.

The permanent magnet of the oscillator may have been magnetized in a direction in which the magnetic pole portions of the magnetic pole member extend.

Two magnetic paths may be formed between the permanent magnet of the oscillator, the magnetic pole portions of the magnetic pole member and the stator.

The fixed portion of the elastic support member may have an extension extending from a part of the fixed portion. The extension may also be fixed to the casing.

The electromagnet of the stator may be formed from a magnetic piece extending in a direction parallel to the oscillator and a coil wound around the magnetic piece.

The permanent magnet of the oscillator may have been magnetized in a direction toward the stator.

The oscillator may further have a support that supports the oscillator.

The support and the elastic support member may be formed as a one-piece member.

The support and the elastic support member may be formed from a single metal plate.

The support may be rectangular in shape, and the pair of arms of the elastic support member may be configured to surround the oscillator supported by the support.

The support and the elastic support member may be connected together at least a part of each of them.

The oscillator may be secured to the support.

The deformable members may be made of a resin.

The elastic support member and a connecting portion of the support may be connected to each other through a bent portion.

The distal end portions of the pair of arms of the elastic support member that are bent to face each other may be integrally connected together. The electromagnetic exciter may further include a support connected to the elastic support member at least a part of the support in the form of a one-piece member.

Thus, the electromagnetic exciter of the present invention has a stator and an oscillator horizontally opposed in a casing. The oscillator is oscillated in a direction parallel to the stator to allow a reduction in thickness of the exciter and also a reduction in thickness of a mobile device in which the electromagnetic exciter is incorporated.

Embodiments of the electromagnetic exciter according to the present invention will be explained below with reference to the accompanying drawings. In the following description of the various embodiments, substantially the same constituent elements are denoted by the same reference numerals.

### BRIEF DESCRIPTION OF THE DRAWINGS

FIG. 1 is a top perspective view of an electromagnetic exciter according to a first embodiment of the present invention.

FIG. 2 is a bottom perspective view of the electromagnetic exciter shown in FIG. 1.

FIG. 3 is a plan view of the electromagnetic exciter in FIG. 1 with an upper casing member removed.

FIG. 4 is a sectional view of the electromagnetic exciter taken along the line IV-IV in FIG. 3.

FIG. 5 is a sectional view of the electromagnetic exciter taken along the line V-V in FIG. 3.

FIG. 6 is an exploded perspective view of a casing of the electromagnetic exciter shown in FIG. 1.

FIG. 7 is an exploded perspective view of a stator of the electromagnetic exciter shown in FIG. 1.

FIG. 8 is a diagram for explaining a process of assembling the stator.

FIG. 9 is a perspective view showing a way in which the stator is assembled.

FIG. 10 is an exploded perspective view of an oscillator of the electromagnetic exciter shown in FIG. 1.

FIG. 11 is a perspective view of the oscillator.

FIG. 12 is a diagram for explaining the driving operation of the electromagnetic exciter shown in FIG. 1.

FIG. 13 is a diagram for explaining the driving operation of the electromagnetic exciter.

FIG. 14 is a diagram similar to FIG. 3, which shows a modification of an elastic support member.

FIG. 15 is an exploded perspective view showing the modification of the elastic support member and the oscillator.

FIG. 16 is a perspective view of a further modified elastic support member.

FIG. 17 is a diagram similar to FIG. 14, which shows an embodiment in which deformable members are provided between the elastic support member and the oscillator.

FIG. 18 is an enlarged view of a main part of FIG. 17, which shows one wedge-shaped deformable member before being fitted.

FIG. 19(a) is a graph showing the damped oscillation characteristics of an electromagnetic exciter provided with the deformable members.

FIG. 19(b) is a graph showing the damped oscillation characteristics of an electromagnetic exciter provided with no deformable members.

FIG. 20 is a graph showing the vibration damping characteristics of the electromagnetic exciter when the deformable members are provided and when they are not provided.

FIG. 21(a) is a diagram showing another example of a method of producing a deformable member.

FIG. 21(b) is a diagram showing the deformable member produced by the method shown in FIG. 21(a).

FIG. 22 is an explanatory view schematically showing a magnetic circuit of the electromagnetic exciter shown in FIG. 17.

FIG. 23 is a diagram similar to FIG. 3, which shows an electromagnetic exciter according to another embodiment of the present invention.

FIG. 24 is a sectional view taken along the line. XXIV-XXIV in FIG. 23.

FIG. 25 is a sectional view taken along the line XXV-XXV in FIG. 23.

FIG. 26 is an exploded perspective view of a casing and a circuit board of the electromagnetic exciter shown in FIG. 23.

FIG. 27 is an exploded perspective view of a stator of the electromagnetic exciter shown in FIG. 23.

FIG. 28 is a perspective view of the stator.

FIG. 29 is an exploded perspective view of an oscillator of the electromagnetic exciter shown in FIG. 23.

FIG. 30 is an exploded perspective view of the oscillator and an elastic support member.

FIG. 31 is a diagram for explaining an operation of the electromagnetic exciter shown in FIG. 23.

FIG. 32 is a diagram for explaining an operation of the electromagnetic exciter shown in FIG. 23.

FIG. 33 is a diagram similar to FIG. 23, which shows an electromagnetic exciter according to still another embodiment of the present invention.

FIG. 34 is a plan view of a blank before it is folded to form an elastic support member and a support of the electromagnetic exciter shown in FIG. 33.

FIG. 35 is a plan view of the elastic support member and the support formed as a one-piece member by folding the blank shown in FIG. 34.

FIG. 36 is a perspective view of the elastic support member and the support shown in FIG. 35.

FIG. 37 is a perspective view of the oscillator and the elastic support member of the electromagnetic exciter shown in FIG. 33.

### DETAILED DESCRIPTION OF THE INVENTION

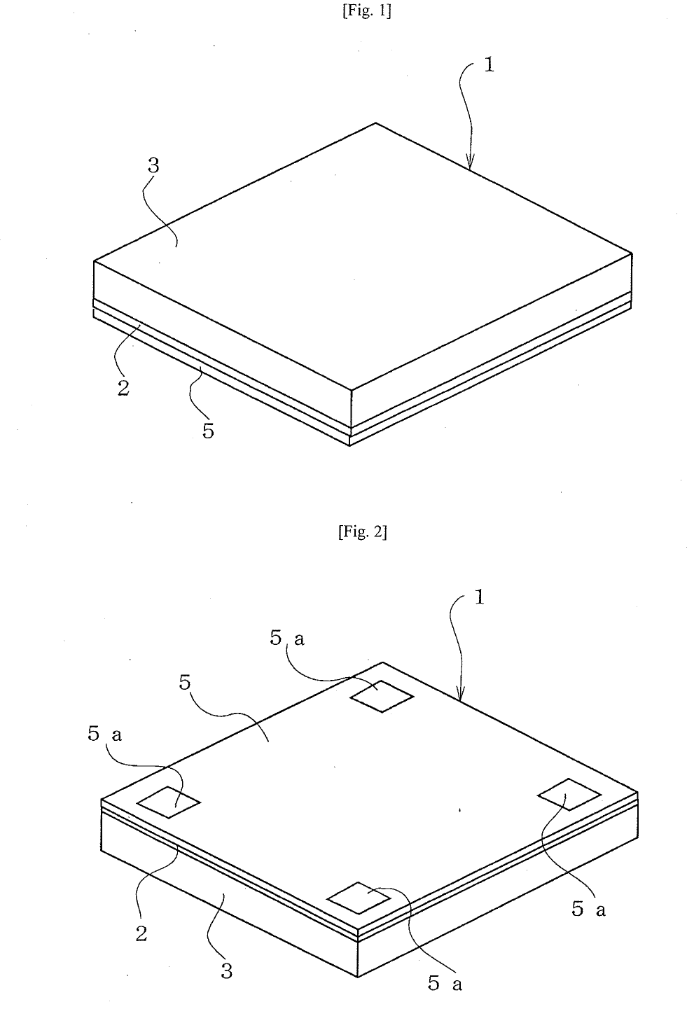

FIGS. 1 to 13 show an electromagnetic exciter 1 according to a first embodiment of the present invention. The electromagnetic exciter 1 has a flat casing comprising a lower casing member 2 and an upper casing member 3. The electromagnetic exciter 1 further has a vibration generating part set in the casing. A circuit board 5 is mounted on the bottom of the lower casing member 2. Connection to an external circuit is made through external connection terminals 5a provided at four corners of the circuit board 5.

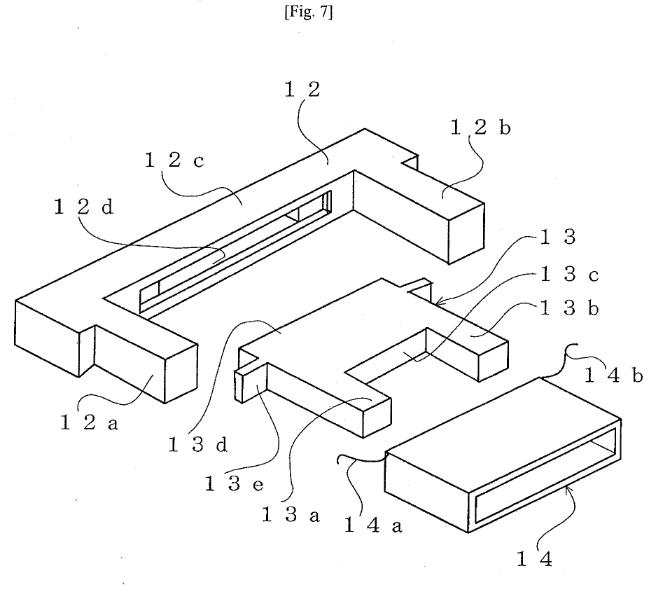

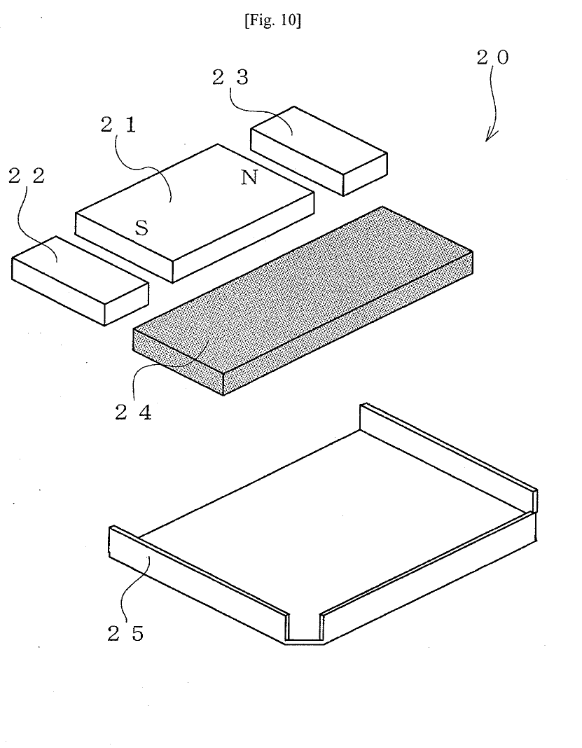

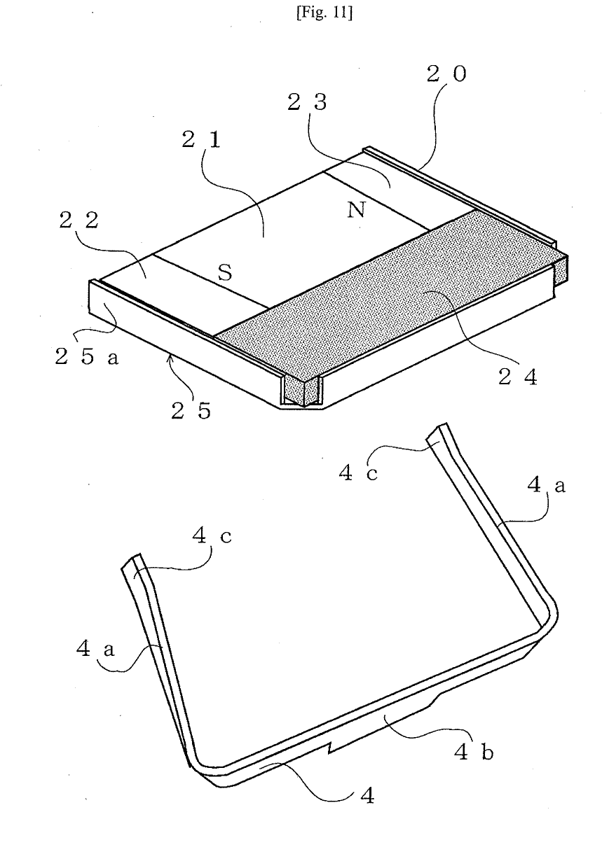

FIG. 3 is a plan view showing the electromagnetic exciter 1 in FIG. 1 with the upper casing member 3 removed to allow the vibration generating part of the electromagnetic exciter 1 to be seen. In the lower casing member 2, a stator 10 and an oscillator 20 are horizontally opposed. The stator 10 comprises a yoke member 12, a pole piece 13, and an electromagnetic coil 14 (see FIGS. 7 to 9) and is secured to the lower casing member 2 by bonding or welding, for example. The oscillator 20 has a permanent magnet 21, magnetic members 22 and 23, and a weight 24 that are integrally accommodated and secured in a support 25 (see FIGS. 10 and 11), which is in the shape of a tray in the illustrated example. The oscillator 20 is oscillatably supported by two arms 4a of a substantially U-shaped elastic support member 4 fixed to one side wall 2b of the lower casing member 2. In the embodiment shown in FIGS. 10 and 11, the support 25 has a bottom wall and three side walls to support the oscillator 20.

Specifically, the elastic support member 4 has a fixed portion 4b fixed to the side wall 2b of the lower casing member 2. The distal end portions of the arms 4a extending from the opposite ends of the fixed portion 4b are secured to the oscillator 20 to hold it from both sides, thus allowing the oscillator 20 to oscillate relative to the lower casing member 2.

The oscillator 20 is larger in size than the stator 10 and has the weight 24 to increase its weight to generate an increased vibration force.

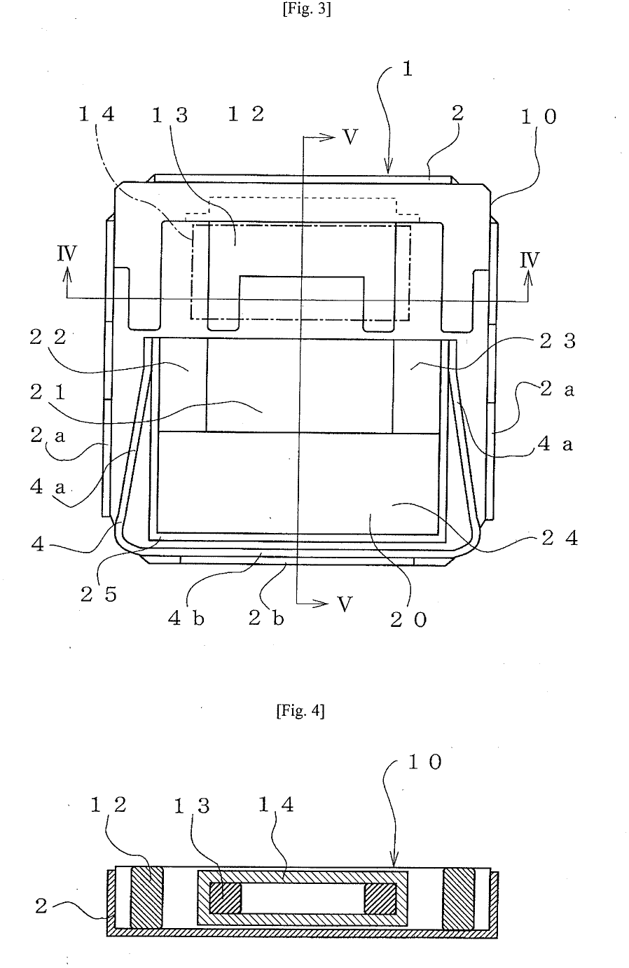

FIG. 4 is a sectional view of the electromagnetic exciter 1 taken along the line IV-IV in FIG. 3, which shows the way in which the stator 10 is fixed to the lower casing member 2. As shown in the figure, the yoke member 12 is fixed to the lower casing member 2, and the pole piece 13 is fixed to the yoke member 12. The coil 14 is set around the pole piece 13. The coil 14 is separated from the lower casing member 2 to prevent the occurrence of a short circuit or other electric problem.

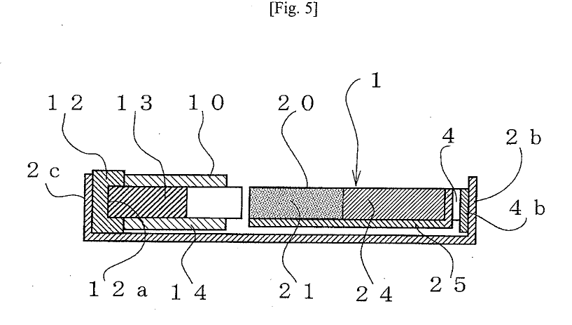

FIG. 5 is a sectional view of the electromagnetic exciter 1 taken along the line V-V in FIG. 3, which shows the positional relationship of the stator 10 and the oscillator 20 relative to the lower casing member 2.

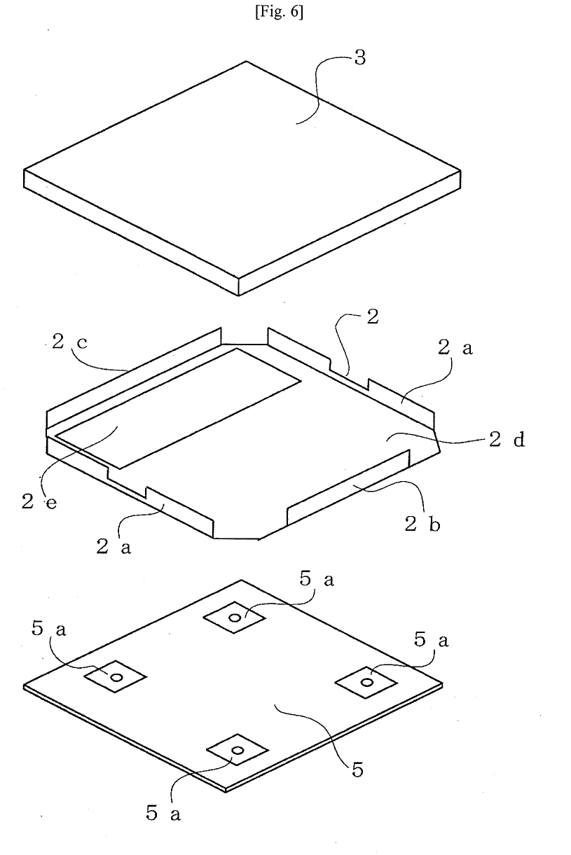

As shown in FIG. 6, the lower casing member 2 has side walls 2a, 2b and 2c and a bottom 2d. To the side wall 2c, the stator 10 is fixed. To the side wall 2b, the oscillator 20 is connected through the elastic support member 4. The bottom 2d has an opening 2e formed at a position where the stator 10 is disposed. Through the opening 2e, the terminal wires of the coil 14 constituting the stator 10 are electrically connected to the external connection terminals 5a of the circuit board 5.

FIGS. 7 to 9 show the process of assembling the stator 10. In FIG. 7, the yoke member 12 is integrally formed with two magnetic pole portions 12a and 12b and a connecting portion 12c that connects together the magnetic pole portions 12a and 12b. The connecting portion 12c is provided on its inner side with a recess 12d for securing the pole piece 13.

The pole piece 13 has two pole portions 13a and 13b provided to be opposed each other across a cut portion 13c and has at its rear end a projection 13d and flange portions 13e provided on two opposite sides, respectively, of the pole piece 13 adjacently to the projection 13d. The coil 14 is an air-core coil and provided with terminal wires 14a and 14b.

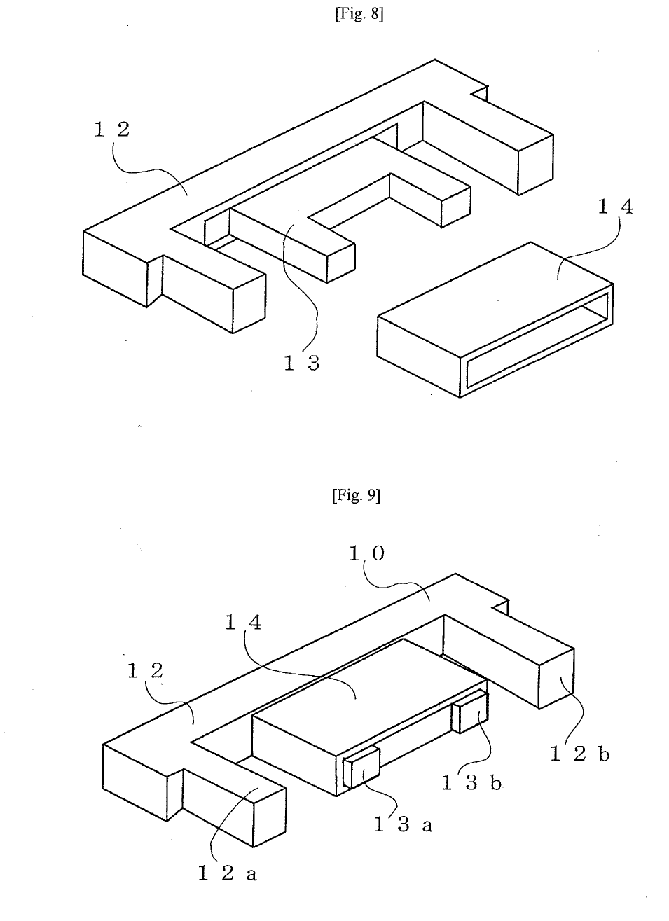

FIG. 8 shows a magnetic base formed by assembling together the yoke member 12 and the pole piece 13. The projection 13d and the flange portions 13e of the pole piece 13 are fitted into the recess 12d of the yoke member 12 and wholly secured by using an adhesive. Alternatively, the pole piece 13 is secured to the yoke member 12 by welding the flange portions 13e. As shown in FIG. 9, the coil 14 is fitted onto the pole piece 13 to complete the stator 10. The magnetic pole portion 12a and the pole portion 13a, which face each other across a gap, form one magnetic pole pair. The magnetic pole portion 12b and the pole portion 13b, which face each other across a gap, form one magnetic pole pair.

The arrangement of the stator 10 may be as follows. The pole piece 13 may be bonded directly to the inner side of the connecting portion 12c of the yoke member without providing a recess like the one 12d on the inner side of the connecting portion 12c. Alternatively, the yoke member 12 may comprise two split portions, which are bonded to the opposite ends of the pole piece 13.

As shown in FIGS. 10 and 11, the oscillator 20 has a permanent magnet 21, two magnetic members 22 and 23 and a weight 24 accommodated in a support 25 having a tray-like shape in the illustrated example and secured to it by using an adhesive or an adhesive sheet. The support 25 in this embodiment has a bottom wall and three side walls. Regarding the elastic support member 4, the fixed portion 4b is wider in width than the distal end portions 4c of the two arms 4a to enhance the adhesion between the elastic support member 4 and the lower casing member 2.

In order to increase the vibration output of the oscillator 20, in this embodiment, the permanent magnet 21 is made of a neodymium sintered alloy, which is excellent in magnetic characteristics and having a relatively high specific gravity of 7.4. The weight 24 is made of a tungsten alloy having a specific gravity of 15 to 18, which is a high specific gravity material. The magnetic members 22 and 23 are made of an SPCC (mild iron or steel), which also has a relatively high specific gravity of 7.85. The oscillator 20 is made less costly by using materials of a relatively high specific gravity to form the permanent magnet 21 and the magnetic members 22 and 23, and thus reducing the amount of tungsten alloy, which is a costly material, used to form the weight 24.

To secure the oscillator 20 to the lower casing member 2 with the elastic support member 4, first, the fixed portion 4b of the elastic support member 4 and the side wall 2b of the lower casing member 2, which is disposed to face the fixed portion 4b, are positioned relative to each other by using a jig and, in this state, welded together. Next, the oscillator 20 is clamped between the two arms 4a of the elastic support member 4 by using their elasticity, and the distal end portions 4c of the two arms 4a of the elastic support member 4 are welded and secured to the forward ends 25a of the side wall surfaces of the support 25 of the oscillator 20. This securing process is preferable from the viewpoint of mass-production. The present invention is, however, not limited to the described process.

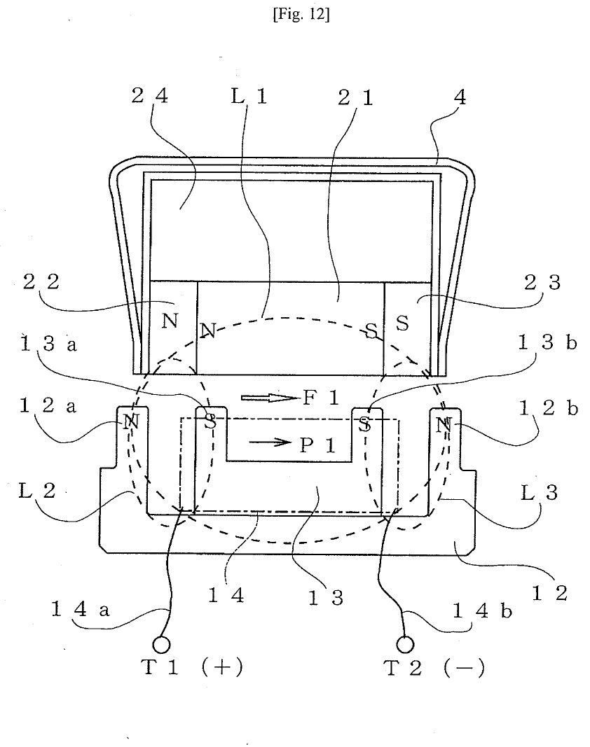

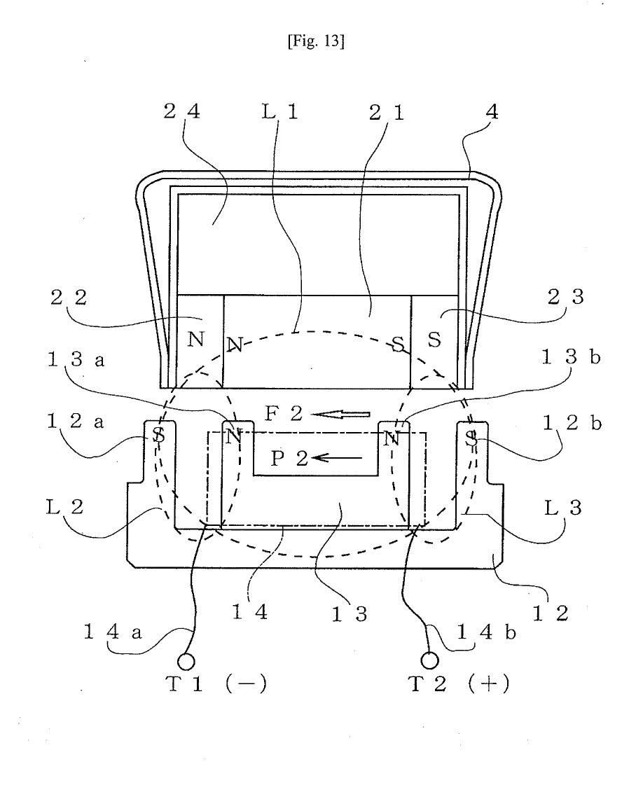

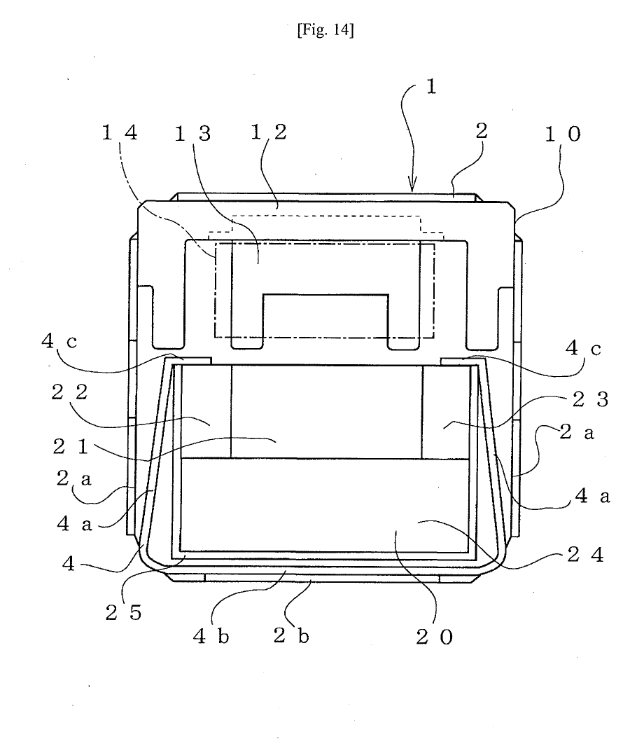

FIGS. 12 and 13 illustrate the operation of the electromagnetic exciter 1. FIGS. 12 and 13 show two different states of the electromagnetic exciter 1 in which an electric current flows through the coil 14 in opposite directions P1 and P2. In the electromagnetic exciter 1, a first magnetic circuit L1 is formed by only the permanent magnet 21, and a second magnetic circuit L2 and a third magnetic circuit L3 are formed by the coil 14 and the permanent magnet 21.

When no driving signal is supplied between terminals T1 and T2 (connected to the external connection terminals 5a of the circuit board 5) connected to the terminal wires 14a and 14b of the coil 14, the oscillator 20 is kept stationary by the static retaining force of the first magnetic circuit L1 formed by the yoke member 12 of the stator 10 and the permanent magnet 21 of the oscillator 20. The relationship between the magnetic pole portions of the stator 10 and the magnetic poles of the permanent magnet 21 of the oscillator 20 concerning the generation of the retaining force in the above-described stationary state is mainly as follows. Magnetic attraction forces are acting between the magnetic member 22 at the north pole side of the permanent magnet 21 and the magnetic pole portion 12a of the yoke member 12, and between the magnetic member 23 at the south pole side of the permanent magnet 21 and the magnetic pole portion 12b of the yoke member 12 to keep the oscillator 20 stationary. In addition, magnetic attraction forces are acting between the magnetic member 22 at the north pole side of the permanent magnet 21 and the pole portion 13a of the pole piece 13, and between the magnetic member 23 at the south pole side of the permanent magnet 21 and the pole portion 13b of the pole piece 13.

In the above-described stationary state, if a positive voltage is supplied to the terminal T1 and a negative voltage to the terminal T2, as shown in FIG. 12, an electric current flows through the coil 14 in the direction P1. The electric current flowing through the coil 14 generates a south pole in the pole portions 13a and 13b of the pole piece 13 and a north pole in the magnetic pole portions 12a and 12b of the yoke member 12. As a result, a second magnetic circuit L2 is formed between the magnetic member 22 of the oscillator 20, the magnetic pole portion 12a of the yoke member 12 and the pole portion 13a of the pole piece 13 of the stator 10. In addition, a third magnetic circuit L3 is formed between the magnetic member 23 of the oscillator 20, the magnetic pole portion 12b of the yoke member 12 and the pole portion 13b of the pole piece 13 of the stator 10.

In the second magnetic circuit L2 formed as stated above, a magnetic repulsion force is generated between the north pole of the magnetic member 22 and the north pole of the magnetic pole portion 12a, and a magnetic attraction force is generated between the north pole of the magnetic member 22 and the south pole of the pole portion 13a. Consequently, a driving force is generated in the direction of the arrow F1. Similarly, in the third magnetic circuit L3, a magnetic repulsion force is generated between the south pole of the magnetic member 23 and the south pole of the pole portion 13b, and a magnetic attraction force is generated between the south pole of the magnetic member 23 and the north pole of the magnetic pole portion 12b. Consequently, a driving force is generated in the direction of the arrow F1. Thus, both the second and third magnetic circuits L2 and L3 generate driving forces in the direction of the arrow F1. Receiving the driving forces, the oscillator 20, which is oscillatably retained by the elastic support member 4, moves in the direction of the arrow F1.

When the voltage supplied between the terminals T1 and T2 is reversed in polarity as shown in FIG. 13, the polarities of the second and third magnetic circuits L2 and L3 become opposite to those in the case of FIG. 12. Consequently, the oscillator 20 receives driving forces in the direction of the arrow F2 and moves in this direction.

In response to the alternating driving voltage (e.g. sine or square wave) applied between the terminals T1 and T2 as stated above, the oscillator 20 oscillates at the cycle of the alternating driving voltage.

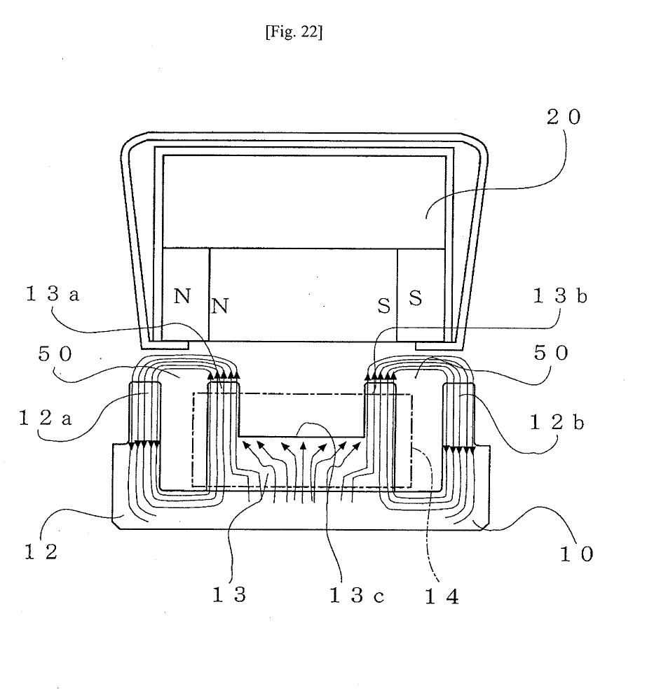

In the above-described electromagnetic exciter 1 of the first embodiment, the stator 10 and the oscillator 20 are horizontally opposed in the flat casing to enable thickness reduction. In addition, the stator 10 forms an E-yoke shaped magnetic circuit from the yoke member 12, the pole piece 13 and the coil 14, and the cut portion 13c is provided in the pole piece 13 to form the pole portions 13a and 13b. The cut portion 13c enables the magnetic flux coming out of the pole piece 13 to converge on the pole portions 13a and 13b more effectively than in the case of providing no cut portion 13c, as shown in FIG. 22, thus increasing the magnetic efficiency of the second and third magnetic circuits L2 and L3.

The oscillator 20 is oscillatably secured to the casing through a substantially U-shaped elastic support member 4 having two arms 4a extending along the side surfaces of the oscillator, and the elastic support member 4 has the distal end portions 4c of the two arms 4a secured to the forward ends of the side walls of the oscillator 20 to allow the two arms 4a to be sufficiently lengthened to generate vibrations that give a favorable bodily sensation.

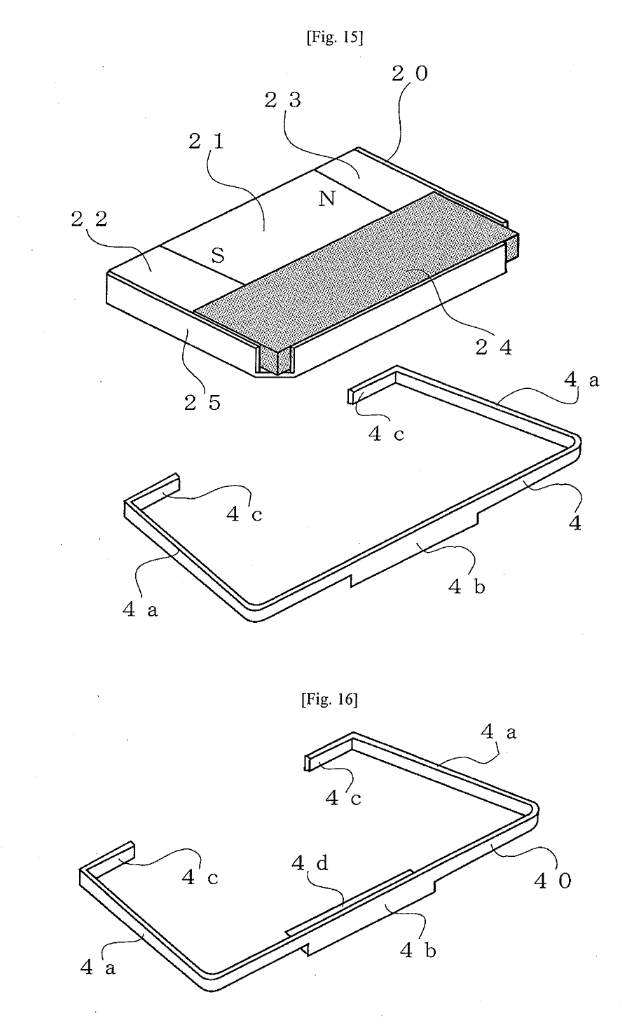

FIG. 15 shows a modification of the elastic support member 4. The modified elastic support member 4 has the distal end portions of the two arms 4a bent to face each other. The distal end portions of the arms 4a are secured to the respective end surfaces of the magnetic members 22 and 23 of the oscillator 20.

FIG. 16 shows another modification of the elastic support member 4 obtained by further modifying the elastic support member shown in FIG. 15. In this modification, the fixed portion 4b is provided with a bent portion 4d, which is secured to the bottom wall surface of the lower casing member 2. As compared to the elastic support member 4 of the electromagnetic exciter 1 explained with reference to FIGS. 1 to 12, these modified elastic support members 4 enable the arms 4a to be lengthened to give an even more favorable vibrational bodily sensation to the user.

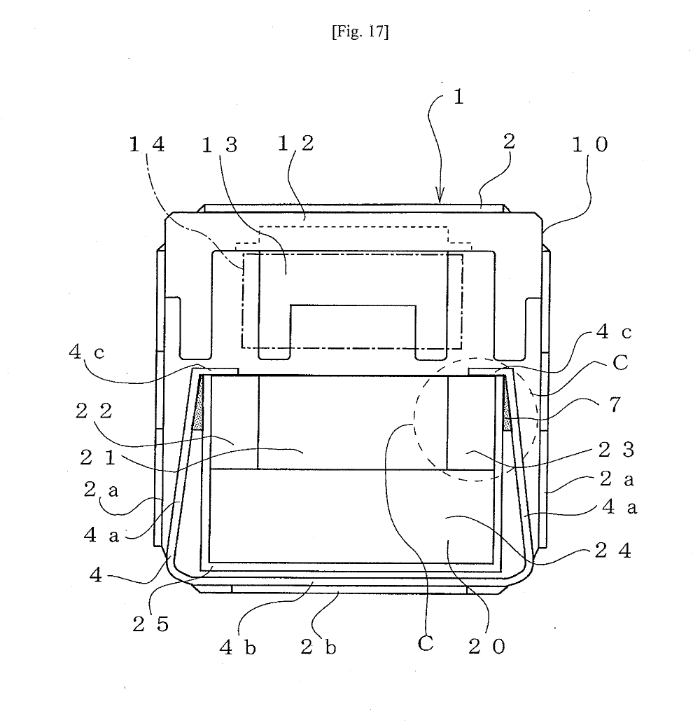

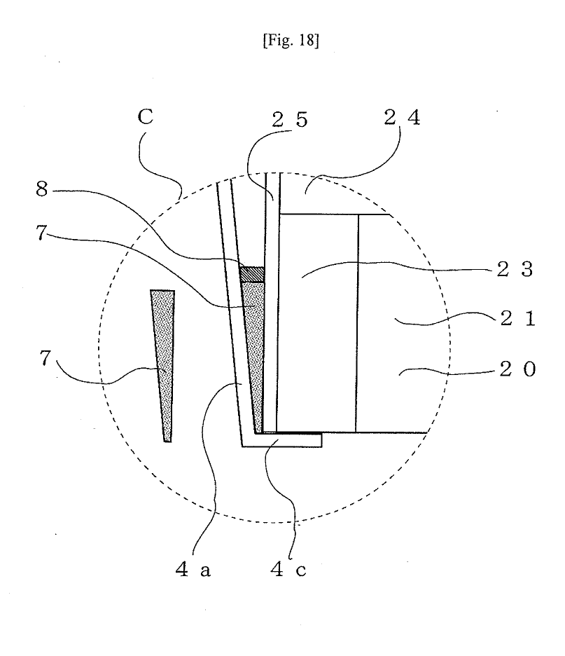

FIGS. 17 and 18 show still another modification. In this modification, wedge-shaped deformable members 7 that damp vibration are fitted between the oscillator 20 and the arms 4a. The deformable members 7 are clamped by the elasticity of the arms 4a. In addition, an adhesive 8 is filled between the oscillator 20 and the arms 4a to secure the deformable members 7 reliably. In this embodiment, the deformable members 7 are respectively provided between the distal ends of the arms 4a and the corresponding side surfaces of the support 25. Any elastic material may be used to form the deformable members 7. Examples of usable deformable members are vibration damping members of resin materials, such as silicone, urethane, fluorine resin and acrylic resins, and α gel and other vibration isolating materials.

In a case where there is no deformable member, when the supply of the driving signal is stopped, the oscillator 20, which has a large weight, vibrates freely by inertia. In a case where the deformable members 7 are provided, an interfering effect occurs between the oscillator 20 and the elastic support member 4, and a damping action takes place.

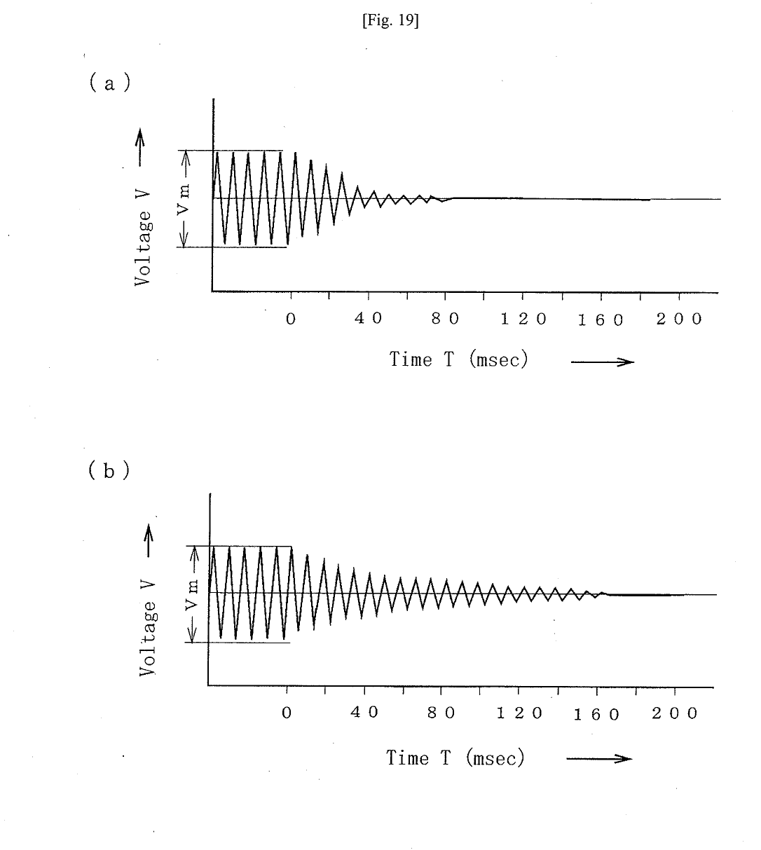

FIG. 19 is a driving waveform chart showing damped oscillation characteristics of the electromagnetic exciter 1, wherein part (a) shows damped oscillation characteristics when the deformable members 7 are provided and part (b) shows damped oscillation characteristics when the deformable members 7 are not provided.

When the supply of the driving voltage Vm stops at the time axis 0, the damping of the vibration of the oscillator 20 starts and the vibration decreases with the passage of time.

As shown in part (a) of FIG. 19, the vibration of the oscillator 20 provided with the deformable members 7 damps to a level where the amplitude is substantially 0 in about a half of the time needed for the oscillator 20 having no deformable members 7, which is shown in part (b) of FIG. 19. It will be understood from FIG. 19 that the deformable members 7 absorb the vibration energy of the oscillator 20 to damp the vibration effectively. The electromagnetic exciter may be combined with a touch switch, for example, and the user may be informed of the confirmation of his or her operation of touching the touch switch, not by a sound but by vibration. In such a case, if it has superior vibration damping characteristics, the electromagnetic exciter can more accurately inform the user of the confirmation of his or her successive operations of the touch switch by vibration.

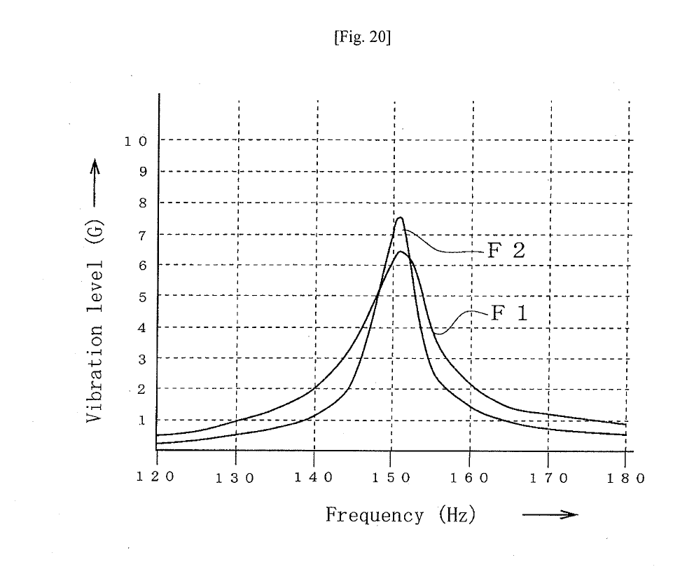

FIG. 20 shows the driving frequency characteristics of the electromagnetic exciter 1 according to the present invention. The abscissa axis represents the frequency (Hz) of the driving signal, and the ordinate axis represents the vibration level (G). The curve F1 shows the characteristics when the deformable members 7 are provided. The curve F2 shows the characteristics when the deformable members 7 are not provided. When the deformable members 7 are not provided, the resonance amplitude is higher and the degree of sharpness Q is higher than those of the structure provided with the deformable members 7. The lower the degree of sharpness Q, the easier it becomes to adjust the electromagnetic exciter 1 with respect to the resonance point, and the easier to control the mass-production of the electromagnetic exciter 1.

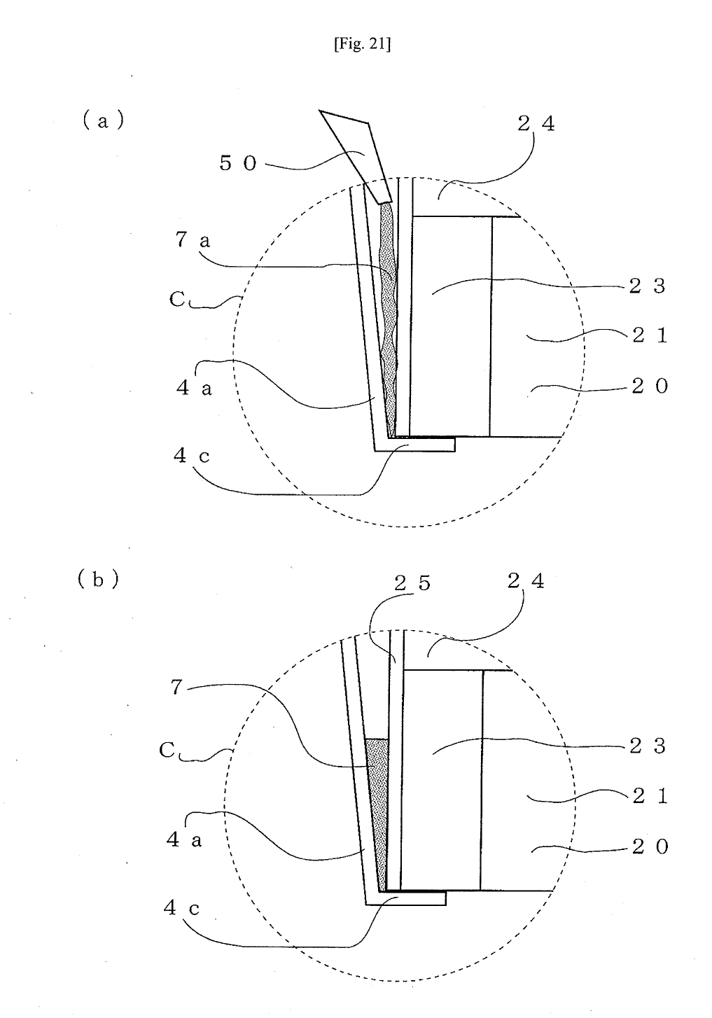

FIG. 21 shows another example of the method of installing the deformable members 7. In this example, as shown in part (a) of FIG. 21, a suitable mount of an elastic adhesive 7a is injected into the gap between the elastic support member 4 and the side surface of the oscillator 20 or the side surface of the support 25 supporting the oscillator 20 by using an injection tool 50. Further, as shown in part (b) of FIG. 21, the elastic adhesive 7a is subjected to a curing treatment to form a deformable member 7.

The above-described method makes it possible to form the deformable member 7 in conformity to the shape of the gap and to obtain adhesion properties. Accordingly, optimal deformable members 7 can be formed efficiently.

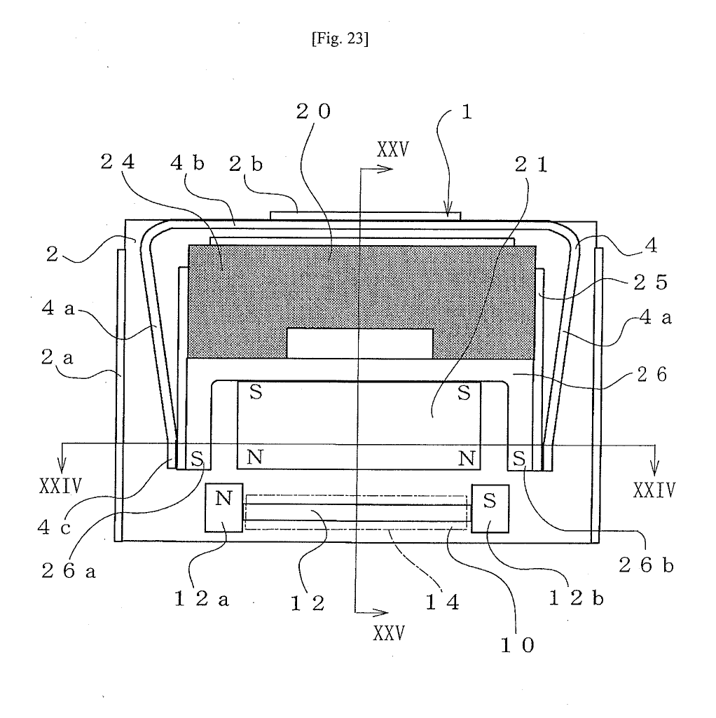

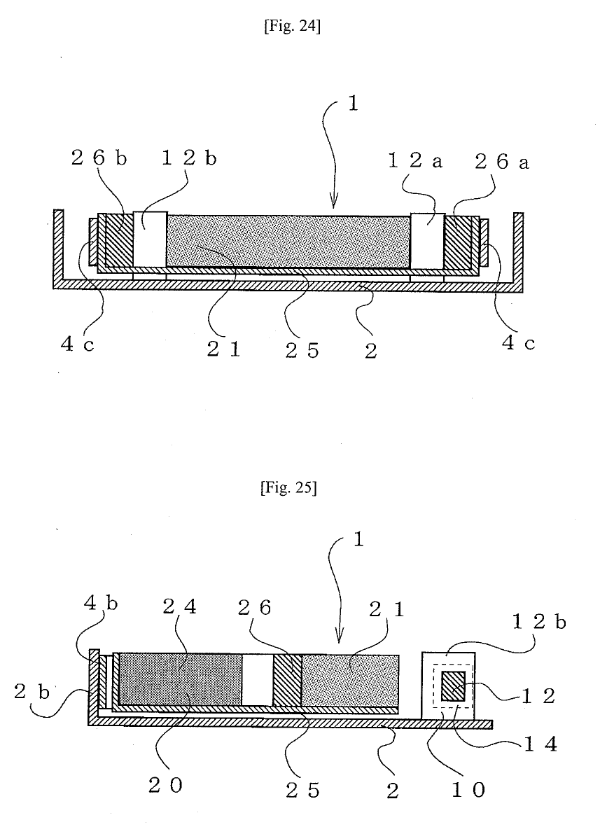

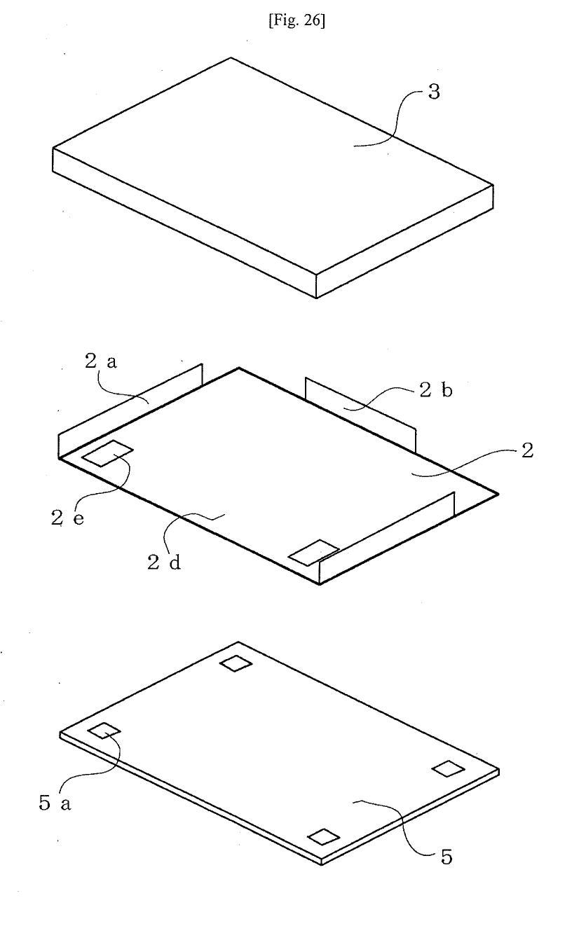

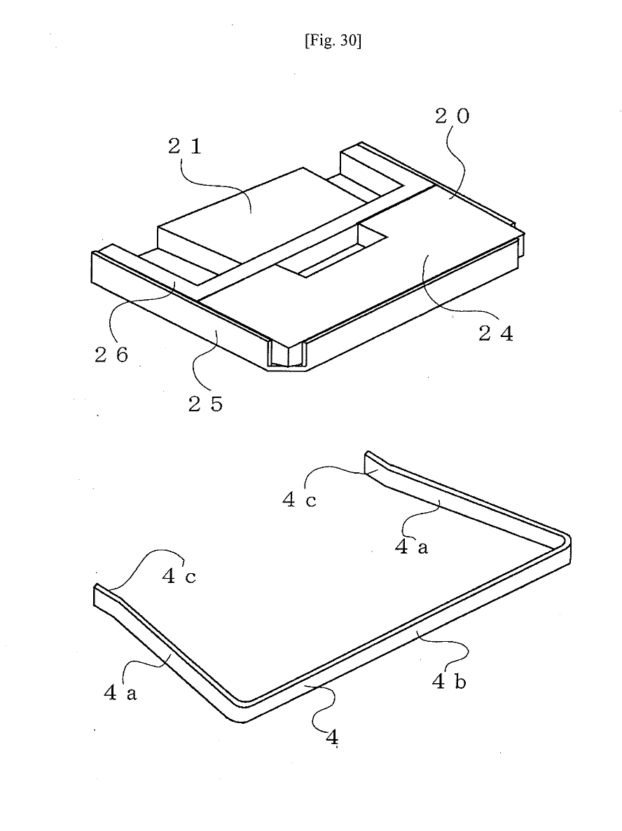

FIGS. 23 to 30 show an electromagnetic exciter 1 according to another embodiment of the present invention. As illustrated in the figures, the electromagnetic exciter 1 is the same as that of the first embodiment shown in FIGS. 1 to 12 in that the stator 10 and the oscillator 20 are disposed in opposing relation to each other, but differs from the first embodiment in terms of the structures of the stator 10 and the oscillator 20.

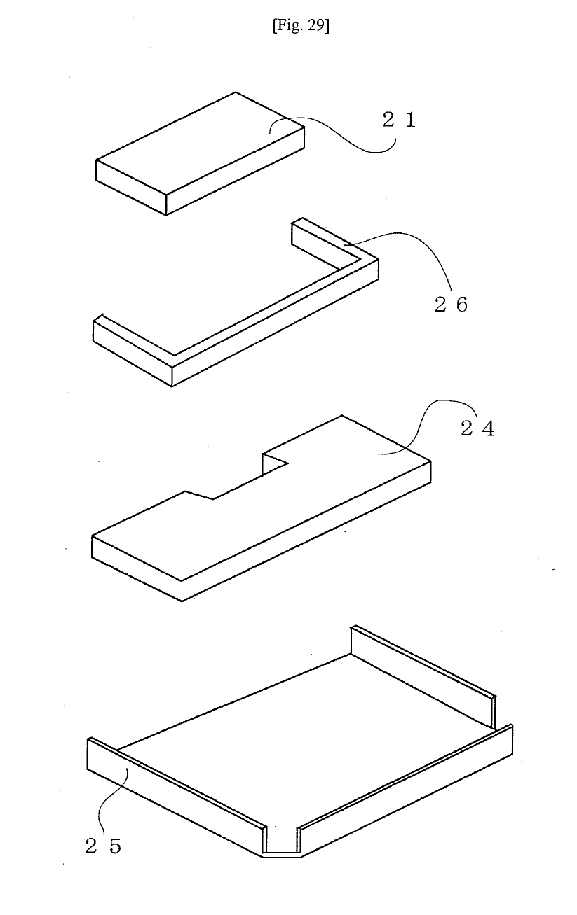

The oscillator 20 comprises, as shown in FIG. 29, a support 25 and a combination of a permanent magnet 21, a U-shaped oscillator yoke 26 and a weight 24 secured to the support 25.

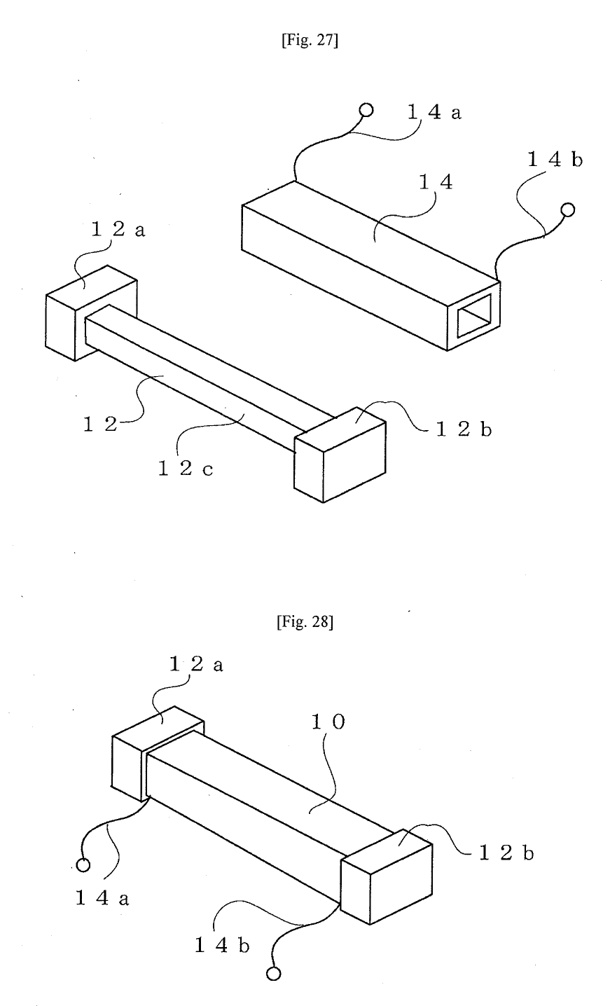

The stator 10 comprises, as shown in FIGS. 27 and 28, a bar-shaped stator yoke 12 formed of a magnetic material and an electromagnetic coil 14 wound around a winding portion 12c of the stator yoke 12. The stator yoke 12 has stator magnetic pole portions 12a and 12b formed at its opposite ends. Reference numerals 14a and 14b denote terminal wires of the electromagnetic coil 14.

The permanent magnet 21, the magnetic pole portions 26a and 26b of the oscillator yoke 26 and the stator magnetic pole portion 12a form a first magnetic path. The permanent magnet 21, the magnetic pole portions 26a and 26b of the oscillator yoke 26 and the stator magnetic pole portion 12b form a second magnetic path.

FIG. 26 is an exploded perspective view of the casing. The lower casing member 2 has an opening 2e formed in its bottom wall 2d at a position where the stator 10 is disposed. Through the opening 2e, the terminal wires of the electromagnetic coil 14 constituting the stator 10 are electrically connected to the external connection terminals 5a of the circuit board 5.

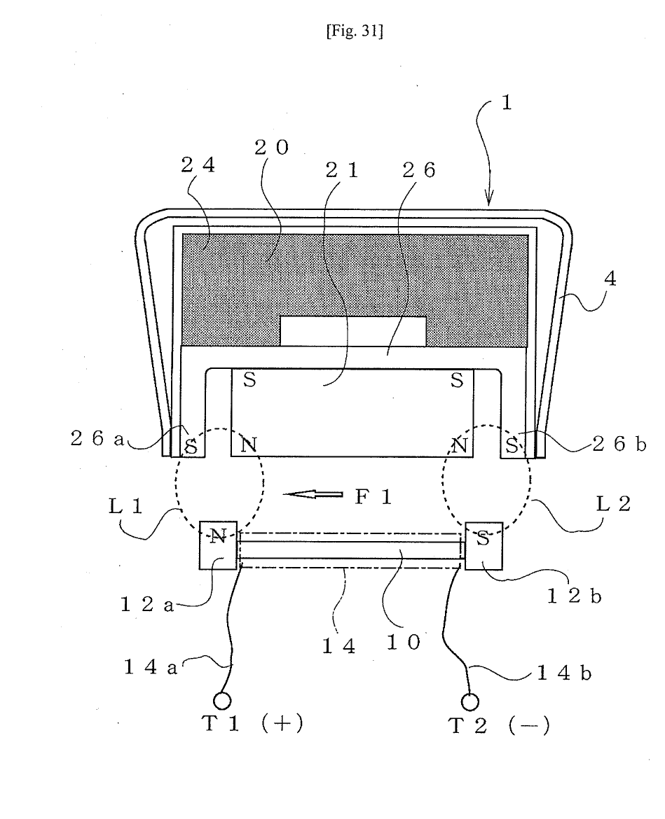

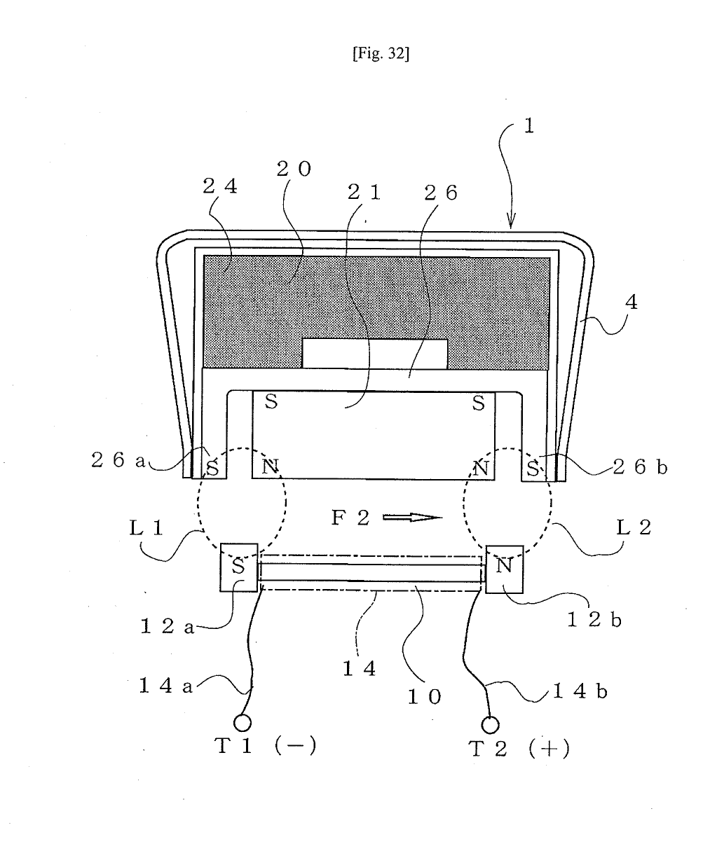

FIGS. 31 and 32 show forces F1 and F2 acting on the oscillator 20 when an alternating current is applied to the electromagnetic coil 14. In this embodiment, the pair of magnetic pole portions of the oscillator yoke 26 are integrally formed in a U-shape with the connecting portion that connects together the magnetic pole portions.

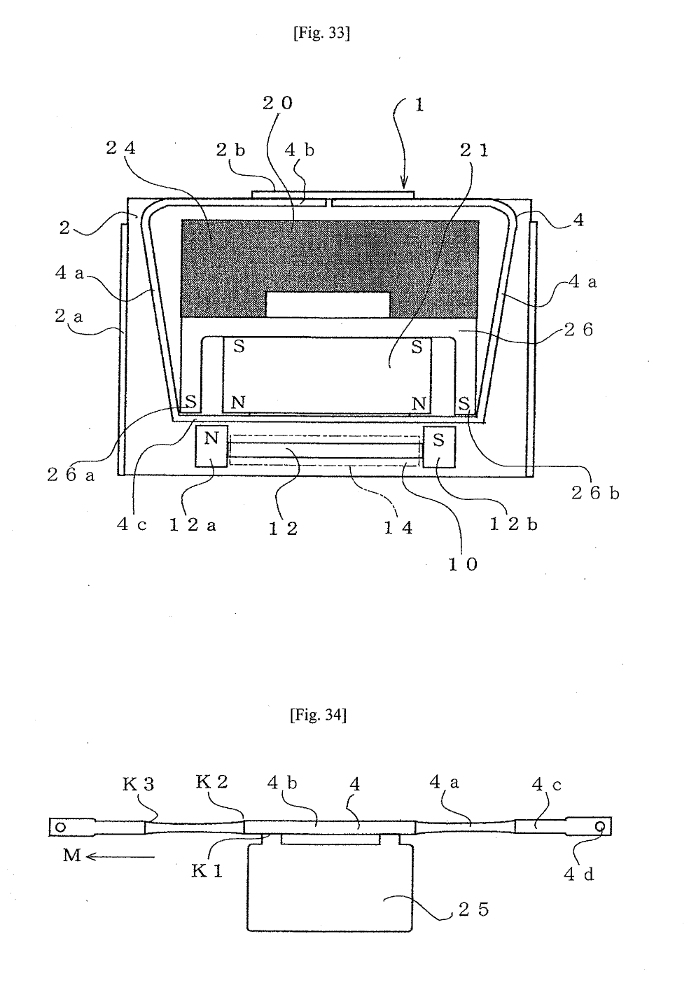

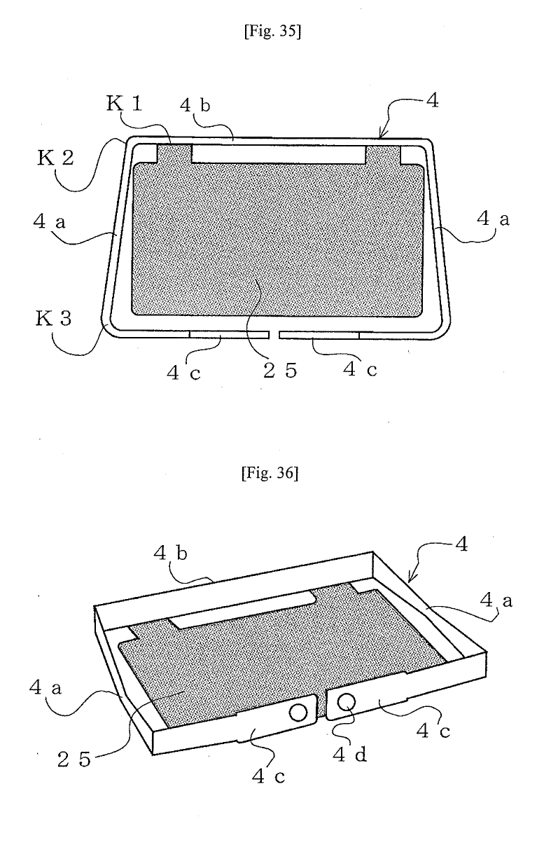

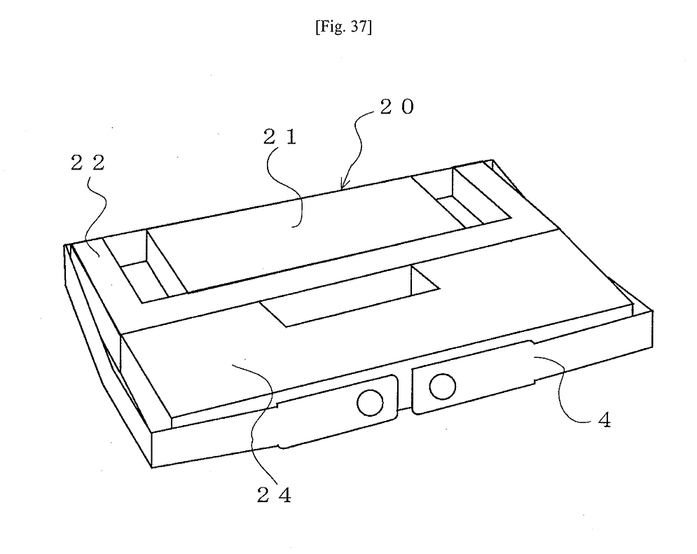

FIGS. 33 to 37 show an electromagnetic exciter according to still another embodiment. The electromagnetic exciter differs from that shown in FIGS. 23 to 30 in that the support 25 and the elastic support member 4 of the oscillator 20 are formed as a single piece (one-piece member) by blanking from a single elastic member in the form of a plate or sheet. The elastic member may be made of a resin or a metal.

If the elastic member is a metal plate, for example, a stainless steel (SUS) plate material of 0.15 mm in thickness may be used as a non-magnetic springy material. The metal plate is blanked to form a blank as shown in FIG. 34. The blank is folded to form the support 25 and the elastic support member 4 as a one-piece member. It should be noted, however, that the thickness of the metal plate is not limited to the above. In view of the metal fatigue of the arms 4a of the elastic support member 4, it is preferable to use a plate material having a rolling direction parallel to the direction of the arrow M in FIG. 34. The arms 4a have a fixed portion 4b that is fixed to the side wall 2b of the lower casing member 2 and distal end portions 4c secured to the respective end surfaces of the magnetic pole portions 26a and 26b of the oscillator yoke 26. The distal end portions 4c are formed integrally with each other.

### INDUSTRIAL APPLICABILITY

The electromagnetic exciter of the present invention can be constructed in a markedly thin structure in comparison to the conventional electromagnetic exciters. Therefore, the electromagnetic exciter is not only usable as a calling vibrator of a thin mobile device such as a mobile phone but also applicable to a touch panel input unit to inform the user that an input has been made properly by vibration.

Although some embodiments of the present invention have been described above, it will be appreciated that the present invention is not limited to the foregoing embodiments but various modifications and changes may be made to the embodiments.

1. An electromagnetic exciter comprising:
a casing;
a stator having an electromagnet and fixed in the casing;
an oscillator having a permanent magnet; and
an elastic support member that positions the oscillator in horizontally-opposed relation to the stator at a distance between each other and that supports the oscillator oscillatably in a direction parallel to the stator, the elastic support member having a fixed portion fixed to the casing and a pair of arms extending from the fixed portion toward the stator along side surfaces of the oscillator to support the oscillator oscillatably;
the oscillator being oscillated by an alternating magnetic field generated by application of an alternating voltage to the electromagnet of the stator.

2. The electromagnetic exciter of claim 1, wherein at least a part of each of the arms of the elastic support member is fixed to a side surface of the oscillator.

3. The electromagnetic exciter of claim 1, wherein distal end portions of the arms of the elastic support member are bent from both sides of the oscillator toward each other and fixed to a surface of the oscillator, the surface facing the stator.

4. The electromagnetic exciter of claim 1, wherein deformable members are clamped between the arms of the elastic support member and the side surfaces of the oscillator corresponding to the arms, respectively.

5. The electromagnetic exciter of claim 1, wherein the elastic support member is of substantially U-shape.

6. The electromagnetic exciter of claim 1, wherein the arms of the elastic support member are opposed each other and a distance between distal end portions of the arms is shorter than a distance between portions other than the distal end portions of the arms.

7. The electromagnetic exciter of claim 5, wherein the permanent magnet has been magnetized in a direction parallel to the stator and has two magnetic pole members respectively secured to the permanent magnet at opposite ends in the direction parallel to the stator.

8. The electromagnetic exciter of claim 7, wherein the oscillator further has a weight disposed between the pair of arms of the elastic support member, the weight being secured to at least one of the permanent magnet and the two magnetic pole members.

9. The electromagnetic exciter of claim 8, wherein the permanent magnet, the two magnetic pole members and the weight of the oscillator are planarly disposed within the U-shape of the elastic support member and integrated together.

10. The electromagnetic exciter of claim 5, wherein the oscillator further has a magnetic pole member of U-shape having a pair of parallel magnetic pole portions and a connecting portion that connects together the magnetic pole portions, the magnetic pole portions extending toward the stator and disposed at a distance from the stator, the permanent magnet being disposed within the U-shape of the magnetic pole member.

11. The electromagnetic exciter of claim 10, wherein the oscillator further has a weight disposed between the pair of arms of the elastic support member and secured to the magnetic member.

12. The electromagnetic exciter of claim 8, wherein the weight is made of a high specific gravity material.

13. The electromagnetic exciter of claim 7, wherein distal end portions of the arms of the elastic support member are secured to the two magnetic pole members, respectively.

14. The electromagnetic exciter of claim 1, further comprising:
a substrate to which the stator and the oscillator are mounted;
wherein the casing is disposed on the substrate, and the elastic support member supports the oscillator oscillatably in a direction parallel to the substrate.

15. The electromagnetic exciter of claim 13, wherein the fixed portion of the elastic support member is fixed to a side wall of the casing.

16. The electromagnetic exciter of claim 1, wherein the fixed portion of the elastic support member is integrally formed with the arms.

17. The electromagnetic exciter of claim 10, wherein the permanent magnet of the oscillator is secured to a part of the magnetic pole member.

18. The electromagnetic exciter of claim 10, wherein the permanent magnet of the oscillator is spaced from the pair of magnetic pole portions of the magnetic member and secured to the connecting portion of the magnetic member.

19. The electromagnetic exciter of claim 18, wherein the permanent magnet of the oscillator has been magnetized in a direction in which the pair of magnetic pole portions of the magnetic member extend.

20. The electromagnetic exciter of claim 19, wherein two magnetic paths are formed between the permanent magnet of the oscillator, the pair of magnetic pole portions of the magnetic member and the stator.

21. The electromagnetic exciter of claim 5, wherein the fixed portion of the elastic support member has an extension extending from a part of the fixed portion, the extension being fixed to the casing.

22. The electromagnetic exciter of claim 1, wherein the electromagnet of the stator comprises a magnetic piece disposed to face the oscillator and a coil wound around the magnetic piece.

23. The electromagnetic exciter of claim 1, wherein the permanent magnet of the oscillator has been magnetized in a direction toward the stator.

24. The electromagnetic exciter of claim 1, further comprising:
a support that supports the oscillator.

25. The electromagnetic exciter of claim 24, wherein the support and the elastic support member are formed as a one-piece member.

26. The electromagnetic exciter of claim 24, wherein the support and the elastic support member are formed from a single metal plate.

27. The electromagnetic exciter of claim 24, wherein the support is rectangular in shape, the pair of arms of the elastic support member being configured to surround at least two side surfaces of the oscillator supported by the support.

28. The electromagnetic exciter of claim 26, wherein the support and the elastic support member are connected together at least a part of each of them.

29. The electromagnetic exciter of claim 26, wherein the oscillator is secured to the support.

30. The electromagnetic exciter of claim 4, wherein the deformable members have elasticity.

31. The electromagnetic exciter of claim 28, wherein the elastic support member and the support are connected to each other through a bent portion.

32. The electromagnetic exciter of claim 1, wherein distal ends of the pair of arms of the elastic support member are integrally connected together, the electromagnetic exciter further comprising:
a support connected to the elastic support member at least a part of the support in a form of a one-piece member.

33. The electromagnetic exciter of claim 32, wherein the support and the elastic support member are formed from a single metal plate.

34. The electromagnetic exciter of claim 24, wherein the support and the elastic support member are discrete from each other.

35. The electromagnetic exciter of claim 30, wherein the deformable members are made of a resin.
